(19) United States
(12) Patent Application Publication
(10) Pub. No.: US 2025/0272573 A1
(43) Pub. Date: Aug. 28, 2025

(54) METHOD AND APPARATUS FOR PROVIDING CUSTOMIZED ARTIFICIAL NEURAL NETWORK MODEL BY USING FEDERATED LEARNING

(71) Applicant: Acryl Inc., Seoul (KR)

(72) Inventors: Su Gi Lee, Seoul (KR); Jong Myeong Choi, Seoul (KR); Jong Yul Kim, Seoul (KR); Eui Yul Koh, Seoul (KR); Wei Jin Park, Seoul (KR); Hyun Kyeong Shin, Seoul (KR)

(73) Assignee: Acryl Inc., Seoul (KR)

(21) Appl. No.: 18/858,520

(22) PCT Filed: Oct. 10, 2023
(86) PCT No.: PCT/KR2023/015491

§ 371 Date: Oct. 21, 2024

(30) Foreign Application Priority Data
Mar. 17, 2023 (KR) 10-2023-0035116

(51) Int. Cl. G06N 3/098

(52) U.S. Cl. CPC G06N 3/098

(57) ABSTRACT

A data market using federated learning is disclosed. According to an embodiment, an operating method of a central server includes providing data provider information to a consumer, receiving, from the consumer, data request information including an artificial neural network (ANN) model, transmitting the data request information to target data providers, receiving, from the target data providers, a result of training of an individually trained ANN model, generating a common model based on the result of the training, and transmitting the common model to the consumer.

### TECHNICAL FIELD

The following embodiments relate to a method of providing a customized artificial neural network (ANN) model using federated learning, and more particularly, to a method of providing a user with a desired ANN model without direct data export using federated learning.

### BACKGROUND ART

An artificial neural network (ANN) is a statistical training algorithm inspired by a neural network of biology (especially the brain of a central nervous system of animals) in machine learning and cognitive science. An ANN refers to the entire model in which an artificial neuron (node) that forms a network by combining synapses changes the intensity of a synaptic connection through training, thereby having an ability to solve problems.

### DISCLOSURE OF THE INVENTION

### Technical Goals

The embodiments are to provide a data market using federated learning.

The embodiments are to provide a method of evaluating data provided by a data provider and providing compensation differentially based on the evaluation result.

The embodiments are to provide a method of predetermining metadata corresponding to each piece of data and determining training data using the metadata.

The technical goals to be achieved by the present invention are not limited to those described above, and other technical goals not mentioned above can be clearly understood from the following description and accompanying drawings by one having ordinary skill in the technical field to which the present invention pertains.

### Technical Solutions

An operating method of a central server according to an embodiment includes providing data provider information to a consumer, receiving, from the consumer, data request information including an artificial neural network (ANN) model, transmitting the data request information to target data providers, receiving, from the target data providers, a result of training of an individually trained ANN model, generating a common model based on the result of the training, and transmitting the common model to the consumer.

The data provider may include a federated learning module capable of communicating with the central server and may be configured to train the ANN model using the federated learning module.

The operating method of the central server according to an embodiment may further include evaluating the result of the training provided by the target data providers, determining a level of contribution of the target data providers based on a result of the evaluation, and determining compensation corresponding to the target data providers, based on the level of contribution.

The evaluating of the result of the training may include obtaining an amount of training data used for the training from each of the target data providers, determining reliability corresponding to each of the target data providers, based on the result of the training, and evaluating the result of the training based on the amount of training data and the reliability.

The provider information may include list information about a data provider and a data format provided by the data provider.

The transmitting of the data request information to the target data providers may include transmitting the ANN model to the target data providers by encrypting the ANN model.

The target data providers may be configured to determine training data corresponding to the ANN model in a database, based on the data request information, and configured to train the ANN model based on the determined training data.

The operating method of the central server according to an embodiment may further include determining the target data providers based on the data request information.

The determining of the target data providers may include receiving, from a data provider, the number of pieces of training data corresponding to the data request information and determining, to be the target data providers, data providers of which the number of pieces of training data is greater than or equal to a predetermined threshold value.

An operating method of a federated learning module according to an embodiment includes inputting data stored in a database to a preprocessing module and extracting metadata corresponding to the data, receiving, from a central server, data request information of a consumer, determining training data corresponding to the data request information of the consumer, based on the metadata, training an ANN model based on the determined training data, and transmitting a result of the training to the central server.

A central server apparatus according to an embodiment includes a transmitter, a receiver, and a processor, in which the transmitter is configured to provide data provider information to a consumer, the receiver is configured to receive, from the consumer, data request information including an ANN model, the transmitter is configured to transmit the data request information to target data providers, the receiver is configured to receive, from the target data providers, a result of training of an individually trained ANN model, the processor is configured to generate a common model based on the result of the training, and the transmitter is configured to transmit the common model to the consumer.

The data provider may include a federated learning module capable of communicating with the central server and may be configured to train the ANN model using the federated learning module.

The processor may be configured to evaluate the result of the training provided by the target data providers, determine a level of contribution of the target data providers based on a result of the evaluation, and determine compensation corresponding to the target data providers, based on the level of contribution.

The processor may be configured to obtain an amount of training data used for the training from each of the target data providers, determine reliability corresponding to each of the target data providers, based on the result of the training, and evaluate the result of the training based on the amount of training data and the reliability.

The transmitter may be configured to transmit the ANN model to the target data providers by encrypting the ANN model.

The receiver may be configured to receive, from a data provider, the number of pieces of training data corresponding to the data request information, and the processor may be configured to determine, to be the target data providers, data providers of which the number of pieces of training data is greater than or equal to a predetermined threshold value.

### BRIEF DESCRIPTION OF DRAWINGS

FIG. 1 is a diagram illustrating a data market according to an embodiment.

FIG. 2 is a block diagram schematically illustrating an operating method of a central server, according to an embodiment.

FIG. 3 is a flowchart illustrating a method of determining compensation, according to an embodiment.

FIG. 4 schematically illustrates a process of generating a common model by determining a weight of each of individual servers, according to an embodiment.

FIG. 5 is a flowchart illustrating an operating method of a federated learning module, according to an embodiment.

FIG. 6 is a block diagram illustrating a central server apparatus according to an embodiment.

### BEST MODE FOR CARRYING OUT THE INVENTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, or similarly, the second component may be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, embodiments will be described in detail with reference to the accompanying drawings. When describing the embodiments with reference to the accompanying drawings, like reference numerals refer to like elements and a repeated description related thereto will be omitted.

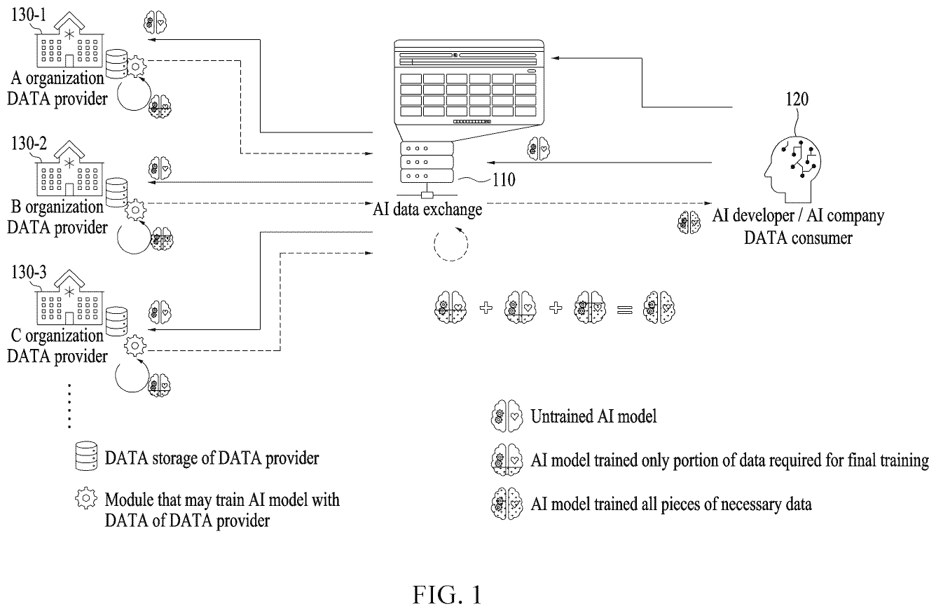

FIG. 1 is a diagram illustrating a data market according to an embodiment.

Referring to FIG. 1, the data market according to an embodiment may include, as main entities, an artificial intelligence (AI) data exchange (hereinafter, referred to as a data exchange) 110, a data consumer (e.g., an AI company or an AI developer) (hereinafter, referred to as a consumer) 120, and a data provider (hereinafter, referred to as a node). The data provider is not limited to an A organization data provider 130-1, a B organization data provider 130-2, and a C organization data provider 130-3 illustrated in the diagram and may include various types and numbers of data providers. As illustrated in FIG. 1, one or more blocks and a combination thereof may be implemented by a special-purpose hardware-based computer that performs a predetermined function or a combination of computer instructions and special-purpose hardware.

The data exchange 110 according to an embodiment may receive, from the data consumer 120, a training request for an artificial neural network (ANN) model and provide, to the consumer 120, the ANN model in which training is completed. The data exchange 110 may include a central server (or a central server apparatus), and the central server may control or monitor a federated learning module installed on the data provider (a plurality of data providers in addition to 130-1 to 130-3). The central server of the data exchange 110 may be connected to a plurality of federated learning modules through a network (not shown). Here, the network may include the Internet, one or more local area networks, wire area networks, cellular networks, mobile networks, other types of networks, or a combination of these networks.

According to an embodiment, the central server may perform federated learning when the federated learning module is installed on each of the data providers. That is, the central server according to an embodiment may perform federated learning even without a platform in which all the data providers and the central server are connected to each other.

According to an embodiment, the data provider (a plurality of data providers in addition to 130-1 to 130-3) may be an entity capable of providing training data for the ANN model. The ‘organization’ according to an embodiment may include a medical institution, a financial institution, a healthcare service company, a personal information management institution, a public institution, a military institution, etc., which are operating the ANN model. Hereinafter, for ease of description, the ‘organization’ is provided based on a medical institution (e.g., a hospital) but is not limited thereto.

The data exchange 110 may provide data provider information to the data consumer 120. The data provider information may include list information about a data provider and a data format provided by the data provider.

The data consumer 120 may view the data provider information and transmit, to the data exchange 110, a data request for training the ANN model that he or she wants. The data request may include data requirements and ANN model information to be trained. For example, the data request may include the type of data to be trained (e.g., medical data), the amount of data (e.g., at least 100,000 or more), the minimum reliability of the data provider (e.g., the minimum reliability of 80 or higher), essential data provider information, etc. The data consumer 120 may transmit, to the data exchange 110, the ANN model to be trained or transmit only information about the ANN model, and the ANN model may be generated in the data exchange 110.

The data exchange 110 may determine, among data providers, a data provider corresponding to the data request. Hereinafter, the data provider corresponding to the data request may be referred to as a target data provider. The data exchange 110 may determine, among the data providers, a target data provider based on the data provider information received from the data consumer 120. The data exchange 110 may determine the target data provider corresponding to the data request by comparing the data provider information with the data request. For example, the data exchange 110 may receive, from the data providers, the number of pieces of training data corresponding to data request information and determine, to be the target data provider, a data provider of which the number of pieces of training data is greater than or equal to a predetermined threshold value.

Alternatively, the target data provider according to an embodiment may be directly designated and determined by the data consumer 120. For example, the data consumer 120 may include desired target data provider information in the data request and transmit the desired target data provider information to the data exchange 110.

The target data provider may be provided in plurality. For example, when the data consumer 120 needs 10,000 pieces of medical data but there is no data provider that may provide 1,000 pieces of medical data alone, this may be solved through federated learning of the data providers.

However, when a plurality of target data providers is used, all pieces of data collected from each of the target data providers must be gathered into one place to train the ANN model, and model training must be performed using a large amount of data. However, data export may be difficult for certain data. For example, in the case of medical data, data export may be prohibited by current laws such as the Medical Act. Accordingly, in an embodiment, it may be possible to use a method of transmitting the ANN model to be trained to the target data providers, training the ANN model based on its own training data in each of the target data providers, and transmitting, back to the data exchange 110, only a parameter of the ANN model in which training is completed. That is, the target data providers may not transmit training data used for training the ANN model but transmit, to the central server of the data exchange 110, the parameter of the ANN model in which training is completed, thereby preventing security issues such as data export in advance.

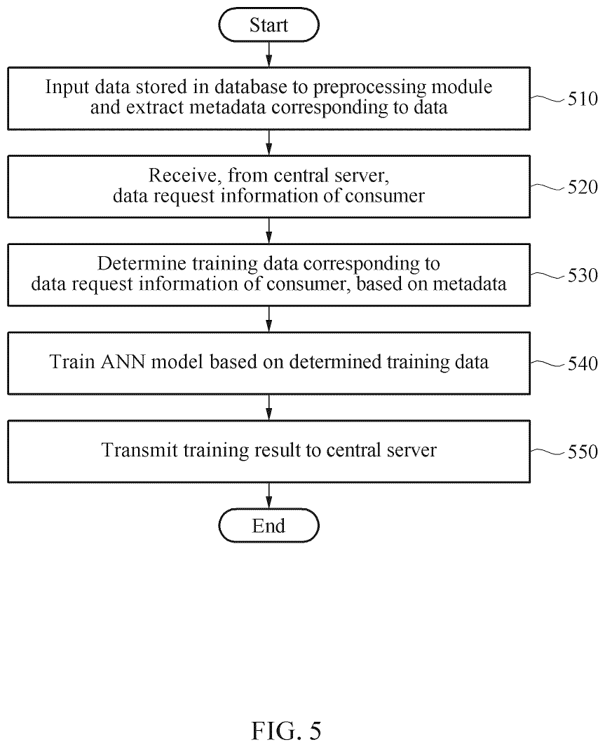

More specifically, the data exchange 110 according to an embodiment may transmit the ANN model to the target data providers. Each of the target data providers may load the ANN model on its federated learning module and train the ANN model. To this end, each of the target data providers may determine training data to be trained among pieces of data stored in a database. A method of determining the training data is described in detail below with reference to FIG. 5.

The target data providers according to an embodiment may train the ANN model based on the determined training data. The ANN model is provided by the data consumer 120, and the A organization data provider 130-1, the B organization data provider 130-2, and the C organization data provider 130-3 may all perform training on the same ANN model. However, the A organization data provider 130-1, the B organization data provider 130-2, and the C organization data provider 130-3 may train the ANN model based on different pieces of training data. For example, the A organization data provider 130-1 may train the ANN model based on first training data, the B organization data provider 130-2 may train the ANN model based on second training data, the C organization data provider 130-3 may train the ANN model based on third training data, and the amount of training data may follow the order of the third training data, the first training data, and the second training data.

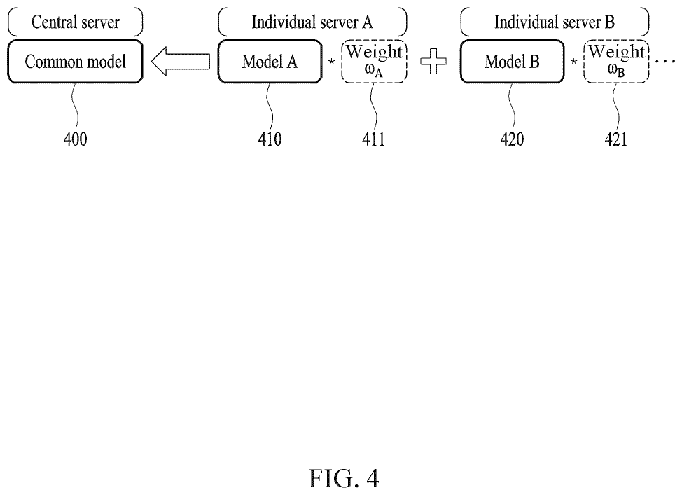

As described in detail below, the central server of the data exchange 110 may receive, from each of the target data providers, the parameter of the ANN model in which training is completed and generate a common model. A specific method of generating the common model is described below with reference to FIG. 4. The central server may then transmit the common model to the data consumer 120.

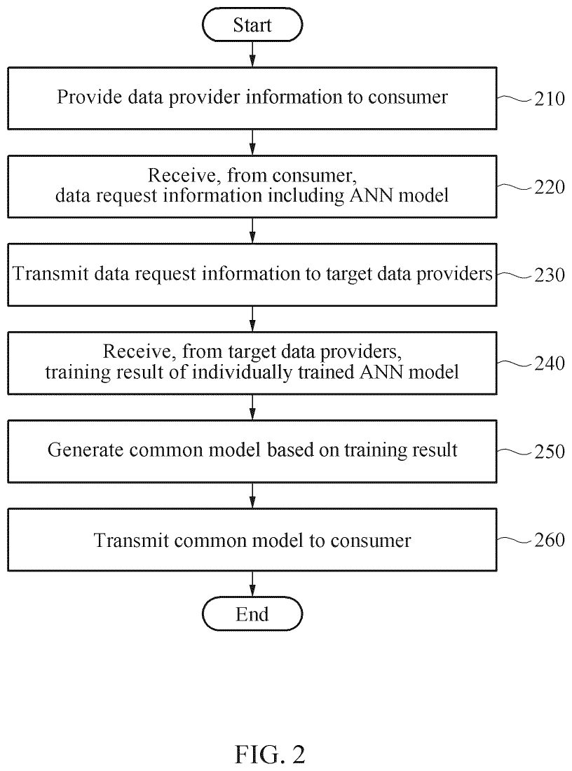

FIG. 2 is a block diagram schematically illustrating an operating method of a central server, according to an embodiment.

The description provided with reference to FIG. 1 may also apply to the description provided with reference to FIG. 2, and any repeated description related thereto is omitted. For ease of description, operations 210 to 260 are described as being performed using the central server described above with reference to FIG. 1. However, operations 210 to 260 may be performed by another suitable electronic device in a suitable system.

Furthermore, the operations of FIG. 2 may be performed in the shown order and manner. However, the order of some operations may be changed or omitted without departing from the spirit and scope of the shown example. The operations shown in FIG. 2 may be performed in parallel or simultaneously.

Referring to FIG. 2, in operation 210, the central server may provide data provider information to a consumer, and in operation 220, the central server may receive, from the consumer, data request information including an ANN model. In operation 230, the central server may transmit the data request information to target data providers. The central server may transmit the ANN model to the target data providers by encrypting the ANN model. For example, the ANN model may be encrypted using a homomorphic encryption method. When the ANN model is encrypted using the homomorphic encryption method, the ANN may be decrypted even when an operation is performed in an encrypted state due to the characteristics of homomorphic encryption.

In operation 240, the central server may receive, from the target data providers, a training result of an individually trained ANN model, and in operation 250, the central server may generate a common model based on the training result, and in operation 260, the central server may transmit the common model to the consumer.

A data provider may include a federated learning module capable of communicating with the central server and train the ANN model using the federated learning module. In operation 240 of receiving the training result of the ANN model, the training result may be a result of the target data providers constructing the ANN model. That is, the central server may receive each ANN model and generate a common ANN model based on the training results of a plurality of ANN models. The target data providers may not individually transmit source data used for training to the central server.

The common model is an ANN model generated by the central server through a series of processes and may be an ANN model in which trained ANN models of individual servers are synthesized, and the generating of the common model may refer to determining a parameter (e.g., a weight) of the common model.

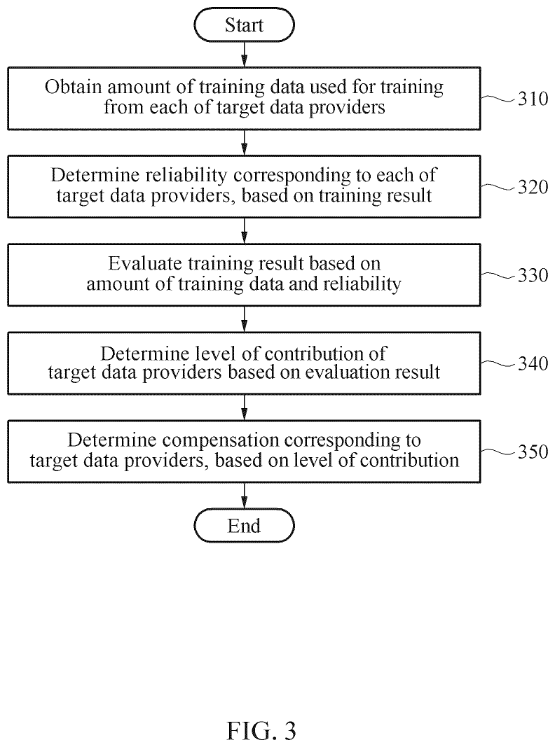

FIG. 3 is a flowchart illustrating a method of determining compensation, according to an embodiment.

The description provided with reference to FIGS. 1 and 2 may also apply to the description provided with reference to FIG. 3, and any repeated description related thereto is omitted. For ease of description, operations 310 to 350 are described as being performed using the central server described above with reference to FIG. 1. However, operations 310 to 350 may be performed by another suitable electronic device in a suitable system.

Furthermore, the operations of FIG. 3 may be performed in the shown order and manner. However, the order of some operations may be changed or omitted without departing from the spirit and scope of the shown example. The operations shown in FIG. 3 may be performed in parallel or simultaneously.

Referring to FIG. 3, in operation 310, a central server may obtain the amount of training data used for training from each of target data providers.

In operation 320, the central server may determine the reliability corresponding to each of the target data providers, based on a training result. According to an embodiment, operation 320 of determining the reliability may include determining the reliability based on situation information received from each of the target data providers. The situation information is information about an unusual situation that is directly received from each of the target data providers, and for example, the situation information may be about a factor that each medical institution determines a situation on its own to specifically increase or decrease a weight of a corresponding individual server.

In addition, the reliability according to an embodiment may be updated based on a comparison with a common model. For example, the central server may quantify data obtained by comparing the performance of an ANN model of each of the target data providers with the performance of the common model, determine the reliability by comparing the numerical values of each of the target data providers, based on the quantified data, and reflect, in the determining of the reliability, the situation information when there is an ANN model of an individual server in which an unusual situation (data that is not trained by other organizations or servers) is reflected.

In another example, the central server may determine the reliability using an attention layer. For example, the central server may input data received from the target data providers to the attention layer, determine an attention weight corresponding to each of the target data providers, and use the attention weight as the reliability.

In operation 330, the central server according to an embodiment may evaluate the training result based on the amount of the training data and the reliability. For example, the central server may evaluate the training result by weighted-summing the amount of the training data and the reliability. The weight used for the weighted sum may be predetermined, or the weight itself may be determined by training.

In operation 340, the central server according to an embodiment may determine a level of contribution of the target data providers based on the evaluation result. For example, the central server may determine that the higher the evaluation result (e.g., the weighted-sum result), the higher the level of contribution.

In operation 350, the central server according to an embodiment may determine compensation corresponding to the target data providers, based on the level of contribution. Accordingly, when a data consumer provides the total compensation to a data exchange, the data exchange may determine the level of contribution of the target data providers and distribute the total compensation to each of the target data providers based on the determined level of contribution.

FIG. 4 schematically illustrates a process of generating a common model by determining a weight of each of individual servers, according to an embodiment.

The description provided with reference to FIGS. 1 to 3 may also apply to the description provided with reference to FIG. 4, and any repeated description related thereto is omitted.

Referring to FIG. 4, a process of determining a weight and generating a common model may include a process of reflecting a weight ω_{A} 411 in a training result of model A 410 and adding a weight ω_{B} 421 to a training result of model B 420, and may further include a process of reflecting and adding individual weights to each of the training results of an ANN model of the target data providers. In the process of generating the common model described above, the number of ANN models is not limited, and in the reflecting of the weight, it is not limited to multiplication as shown in FIG. 4, is not limited to adding a model in which a weight is reflected to a model of each individual server, and the common model may be generated in various ways using an aggregation function.

A central server 400 according to an embodiment may generate a list of the target data providers that have completed receiving the training result and generate the common model based on the generated list. Among the target data providers, a parameter of an ANN model in which training is not completed may be prevented from being reflected in the common model. For example, the target data providers may transmit the training result and an ack signal together. The central server 400 may consider generating the common model through the received training result and ack signal.

FIG. 5 is a flowchart illustrating an operating method of a federated learning module, according to an embodiment.

For ease of description, operations 510 to 550 are described as being performed using the federated learning module described above with reference to FIG. 1. However, operations 510 to 550 may be performed by another suitable electronic device in a suitable system.

Furthermore, the operations of FIG. 5 may be performed in the shown order and manner. However, the order of some operations may be changed or omitted without departing from the spirit and scope of the shown example. The operations shown in FIG. 5 may be performed in parallel or simultaneously.

Referring to FIG. 5, in operation 510, the federated learning module according to an embodiment may input data stored in a database to a preprocessing module and extract metadata corresponding to the data. The preprocessing module according to an embodiment may be an ANN model. The metadata according to an embodiment may include information about the type of corresponding data. The metadata may include information about which ANN model the corresponding data may be used for training. For example, the type of a plurality of ANN models may be predetermined, and the preprocessing module may determine which ANN model the data may be used for training and store the data as the metadata.

In operation 520, the federated learning module according to an embodiment may receive, from a central server, data request information of a consumer.

In operation 530, the federated learning module according to an embodiment May determine training data corresponding to the data request information of the consumer, based on the metadata. For example, the federated learning module may determine the training data that may be used for training the ANN model included in the data request information of the consumer, using the metadata.

In another embodiment, the federated learning module according to an embodiment may determine the training data without using the metadata. For example, target data providers may determine common data to be the training data.

In operation 540, the federated learning module according to an embodiment may train the ANN model based on the determined training data.

In operation 550, the federated learning module according to an embodiment May transmit the training result to the central server.

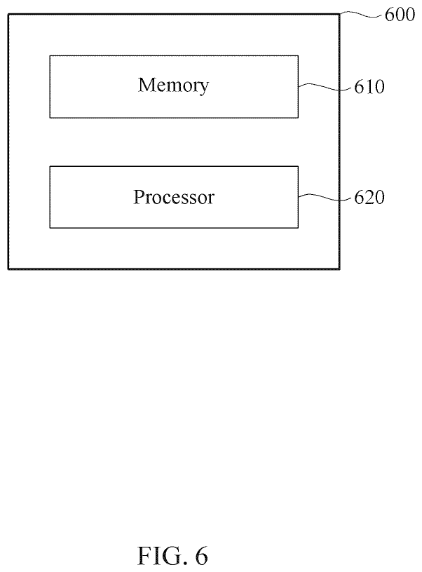

FIG. 6 is a block diagram illustrating a central server apparatus according to an embodiment.

As illustrated in FIG. 6, one or more blocks and a combination thereof may be implemented by a special-purpose hardware-based computer that performs a predetermined function or a combination of computer instructions and special-purpose hardware.

As shown in FIG. 6, an apparatus 600 may include a memory 610 and a processor 620. The apparatus 600 may further include a communication module, and the communication module may include a transmitter and a receiver.

The apparatus 600 according to an embodiment may include the memory 610 and the processor 620 connected to the memory 610 through a system bus or another appropriate circuit.

The apparatus 600 may store program code in the memory 610. The memory 610 according to an embodiment may include a local memory or one or more physical memory devices, such as one or more bulk storage devices. Here, the local memory may include random access memory (RAM) or other volatile memory devices that are generally used during actual execution of the program code. The bulk storage devices may be implemented as a hard disk drive (HDD), a solid-state drive (SSD), or other non-volatile memory devices.

In response to execution of executable program code stored in the memory 610 by the apparatus 600, the processor 620 may perform various operations disclosed herein. For example, the memory 610 may store the program code such that the processor 620 may perform one or more operations described with reference to FIGS. 1 to 4.

Depending on a specific type of apparatus to be implemented, the apparatus 600 may include less components than those shown in FIG. 6 or may include additional components not shown in FIG. 6. Also, one or more components may be included in another component and may constitute a portion of the other component.

The processor 620 according to an embodiment is a hardware configuration that performs overall control functions for controlling operations of the apparatus 600. For example, the processor 620 may generally control the apparatus 600 by executing programs stored in the memory 610 in the apparatus 600. The processor 620 may be implemented as a central processing unit (CPU), a graphics processing unit (GPU), an application processor (AP), a neural processing unit (NPU), and the like that are included in the apparatus 600, but embodiments are not limited thereto.

More specifically, the transmitter may provide data provider information to a consumer, the receiver may receive, from the consumer, data request information including an ANN model, the transmitter may transmit the data request information to target data providers, the receiver may receive, from the target data providers, a training result of an individually trained ANN model, the processor 620 may generate a common model based on the training result, and the transmitter may transmit the common model to the consumer.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, a person skilled in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Accordingly, other implementations are within the scope of the following claims.

1. An operating method of a central server, the operating method comprising:
providing data provider information to a consumer;
receiving, from the consumer, data request information comprising an artificial neural network (ANN) model;
transmitting the data request information to target data providers;
receiving, from the target data providers, a result of training of an individually trained ANN model;
generating a common model based on the result of the training; and
transmitting the common model to the consumer.

2. The operating method of claim 1, wherein the data provider comprises a federated learning module capable of communicating with the central server and is configured to train the ANN model using the federated learning module.

3. The operating method of claim 1, further comprising:
evaluating the result of the training provided by the target data providers;
determining a level of contribution of the target data providers based on a result of the evaluation; and
determining compensation corresponding to the target data providers, based on the level of contribution.

4. The operating method of claim 1, wherein the evaluating of the result of the training comprises:
obtaining an amount of training data used for the training from each of the target data providers;
determining reliability corresponding to each of the target data providers, based on the result of the training; and
evaluating the result of the training based on the amount of training data and the reliability.

5. The operating method of claim 1, wherein the provider information comprises list information about a data provider and a data format provided by the data provider.

6. The operating method of claim 1, wherein the transmitting of the data request information to the target data providers comprises transmitting the ANN model to the target data providers by encrypting the ANN model.

7. The operating method of claim 1, wherein the target data providers are configured to determine training data corresponding to the ANN model in a database, based on the data request information, and configured to train the ANN model based on the determined training data.

8. The operating method of claim 1, further comprising:
determining the target data providers based on the data request information.

9. The operating method of claim 8, wherein the determining of the target data providers comprises:
receiving, from a data provider, a number of pieces of training data corresponding to the data request information; and
determining, to be the target data providers, data providers of which the number of pieces of training data is greater than or equal to a predetermined threshold value.

10. An operating method of a federated learning module, the operating method comprising:
inputting data stored in a database to a preprocessing module and extracting metadata corresponding to the data;
receiving, from a central server, data request information of a consumer;
determining training data corresponding to the data request information of the consumer, based on the metadata;
training an artificial neural network (ANN) model based on the determined training data; and
transmitting a result of the training to the central server.

11. A computer program stored in a non-transitory computer-readable medium, the computer program being configured to perform the operating method of claim 1 in combination with hardware.

12. A central server apparatus comprising:
a transmitter;
a receiver; and
a processor,
wherein the transmitter is configured to provide data provider information to a consumer,
wherein the receiver is configured to receive, from the consumer, data request information comprising an artificial neural network (ANN) model,
wherein the transmitter is configured to transmit the data request information to target data providers,
wherein the receiver is configured to receive, from the target data providers, a result of training of an individually trained ANN model,
wherein the processor is configured to generate a common model based on the result of the training,
wherein the transmitter is configured to transmit the common model to the consumer.

13. The central server apparatus of claim 12, wherein the data provider comprises a federated learning module capable of communicating with the central server and is configured to train the ANN model using the federated learning module.

14. The central server apparatus of claim 12, wherein the processor is configured to:
evaluate the result of the training provided by the target data providers;
determine a level of contribution of the target data providers based on a result of the evaluation;
determine compensation corresponding to the target data providers, based on the level of contribution.

15. The central server apparatus of claim 12, wherein the processor is configured to:
obtain an amount of training data used for the training from each of the target data providers;
determine reliability corresponding to each of the target data providers, based on the result of the training;
evaluate the result of the training based on the amount of training data and the reliability.
